(19) United States
(12) Patent Application Publication
(10) Pub. No.: US 2026/0329123 A1
(43) Pub. Date: Oct. 22, 2026

(54) ELECTRO-OPTICAL DEVICE AND ELECTRONIC APPARATUS

(71) Applicant: SEIKO EPSON CORPORATION, Tokyo (JP)

(72) Inventors: Hiroaki SHIMIZU, OKAYA-SHI (JP); Shuji TERADA, MATSUMOTO-SHI (JP)

(73) Assignee: SEIKO EPSON CORPORATION, Tokyo (JP)

(21) Appl. No.: 19/529,058

(22) Filed: Feb. 3, 2026

(30) Foreign Application Priority Data
Feb. 6, 2025 (JP) 2025-018272

(51) Int. Cl. G02F 1/1333; G02F 1/1335

(52) U.S. Cl. CPC G02F 1/133382; G02F 1/133526

(57) ABSTRACT

An electro-optical device includes a first substrate having a plurality of pixel electrodes and an external coupling terminal portion that supplies an electric signal to each of the plurality of pixel electrodes, a second substrate disposed to face the first substrate, and an electro-optical material layer sandwiched between the first substrate and the second substrate, wherein a rectangular overlapping region in which the first substrate and the second substrate overlap each other, a first protruding region in which the first substrate protrudes to an outside of the second substrate is provided outside a first side, a second protruding region in which one of the first substrate and the second substrate protrudes to an outside, and the substrate at the side protruding to the second protruding region includes a thermally conductive layer made of a material having higher thermal conductivity than a constituent material of the substrate.

The present application is based on, and claims priority from JP Application Serial Number 2025-018272, filed Feb. 6, 2025, the disclosure of which is hereby incorporated by reference herein in its entirety.

### BACKGROUND

### 1. Technical Field

The present disclosure relates to an electro-optical device and an electronic apparatus.

### 2. Related Art

As an electro-optical device, a liquid crystal panel configured with a liquid crystal layer as an electro-optical material layer sandwiched between a pair of substrates is known. For example, JP-A-2022-15018 discloses a technique using a liquid crystal device including a liquid crystal panel, a holder that holds the liquid crystal panel, and a heat sink provided in the holder as a liquid crystal light valve of a projector. In this liquid crystal device, heat of the liquid crystal panel generated by light incident from a light source is released via the holder and the heat sink.

JP-A-2022-15018 is an example of the related art.

However, in the above-described liquid crystal device, it is difficult to sufficiently dissipate heat from the entire liquid crystal panel, and it is desired to provide a new technique capable of improving the heat dissipation of the liquid crystal panel.

### SUMMARY

An electro-optical device according to an aspect of the present disclosure includes a first substrate having a plurality of pixel electrodes and an external coupling terminal portion that supplies an electric signal to each of the plurality of pixel electrodes, a second substrate disposed to face the first substrate, and an electro-optical material layer sandwiched between the first substrate and the second substrate, wherein a rectangular overlapping region in which the first substrate and the second substrate overlap each other when viewed from a normal direction of the first substrate and the second substrate is provided, a first protruding region in which the first substrate protrudes to an outside of the second substrate is provided outside a first side among four sides of the overlapping region, and the external coupling terminal portion is provided in the first protruding region, a second protruding region in which one of the first substrate and the second substrate protrudes to an outside of the other is provided outside a second side different from the first side, and the substrate at the side protruding to the second protruding region includes a thermally conductive layer made of a material having higher thermal conductivity than a constituent material of the substrate.

An electronic apparatus according to another aspect of the present disclosure includes the electro-optical device according to the above aspect.

### BRIEF DESCRIPTION OF THE DRAWINGS

FIG. 1 is a schematic plan view showing a configuration of a liquid crystal device according to a first embodiment.

FIG. 2 is a schematic diagram showing a cross-sectional structure taken along line II-II as seen in a direction of arrows in FIG. 1.

FIG. 3 shows a planar shape of a thermally conductive layer.

FIG. 4A is a schematic plan view showing a configuration of a liquid crystal device according to a first modification.

FIG. 4B is a schematic plan view showing a configuration of a liquid crystal device according to a second modification.

FIG. 4C is a schematic plan view showing a configuration of a liquid crystal device according to a third modification.

FIG. 4D is a schematic plan view showing a configuration of a liquid crystal device according to a fourth modification.

FIG. 5 is a schematic diagram showing a cross- sectional structure of a liquid crystal device according to a second embodiment.

FIG. 6 is a schematic diagram showing a cross-sectional structure of a liquid crystal device according to a third embodiment.

FIG. 7 is a schematic diagram showing a cross-sectional structure of a liquid crystal device according to a fourth embodiment.

FIG. 8 is a schematic diagram showing a cross-sectional structure of a liquid crystal device according to a fifth embodiment.

FIG. 9 is a schematic diagram showing a cross-sectional structure of a liquid crystal device according to a sixth embodiment.

FIG. 10 is a schematic diagram showing a cross-sectional structure of a liquid crystal device according to a seventh embodiment.

FIG. 11 is a schematic diagram showing a cross-sectional structure of a liquid crystal device according to an eighth embodiment.

FIG. 12 is a schematic diagram showing a configuration of an electronic apparatus according to a ninth embodiment.

### DESCRIPTION OF EMBODIMENTS

Embodiments of the present disclosure will be described below with reference to the drawings. The present disclosure is not limited to the following embodiments, and includes various modifications implemented without departing from the scope of the present disclosure.

In the respective following drawings, X, Y, and Z axes are shown as coordinate axes orthogonal to one another as necessary, a direction indicated by an arrow is referred to as a + direction, and a direction opposite to the + direction is referred to as a - direction. The +Y side may be referred to as an upside, the -Y side may be referred to as a downside, the +X side may be referred to as a right side, and the -X side may be referred to as a left side. A plane including the X axis and the Y axis is also referred to as an XY plane, and the view of the XY plane from the +Z direction is also referred to as a plan view or a planar view. In the following drawings, in order to easily recognize layers and members, the scales of the layers and the members are made different from the actual scales.

### First embodiment

In the present embodiment, an active drive type liquid crystal device 1 including a thin film transistor (hereinafter, abbreviated as "TFT") as a transistor for each pixel is exemplified as an electro-optical device. The liquid crystal device 1 is suitable as, for example, a light modulation element (liquid crystal light valve) of a projection-type display apparatus as an electronic apparatus described later.

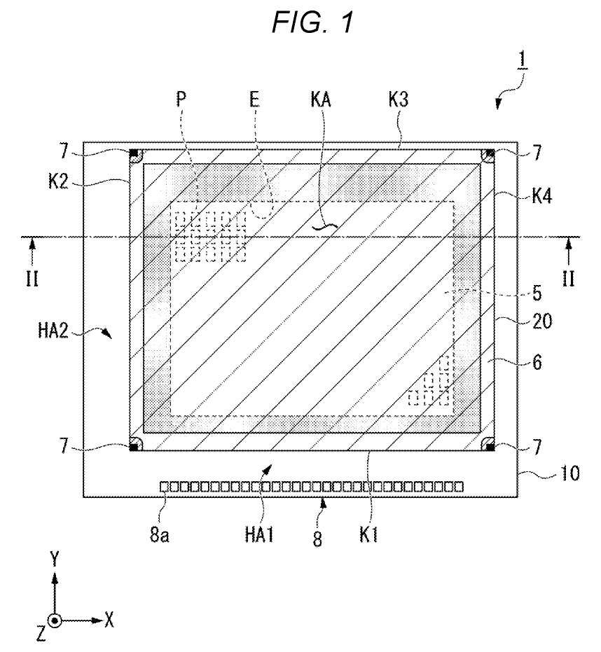

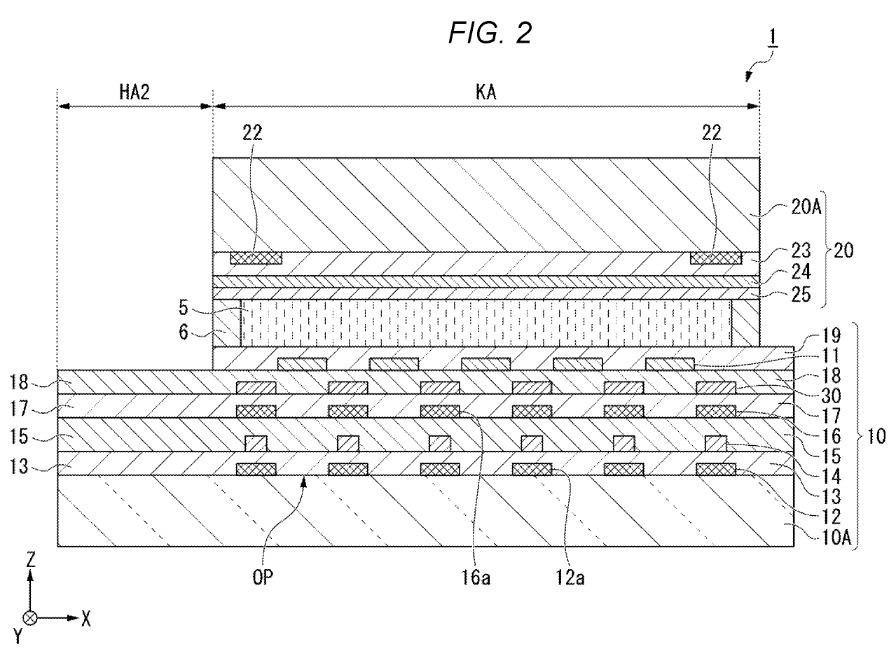

FIG. 1 is a schematic plan view showing a configuration of the liquid crystal device according to the present embodiment. FIG. 2 is a schematic diagram showing a cross-sectional structure taken along line II-II as seen in a direction of arrows in FIG. 1.

As illustrated in FIGS. 1 and 2, the liquid crystal device (electro-optical device) 1 of the present embodiment is a liquid crystal panel including an element substrate (first substrate) 10, a counter substrate (second substrate) 20 disposed to face the element substrate 10, and a liquid crystal layer (electro-optical material layer) 5 containing liquid crystal sandwiched between the element substrate 10 and the counter substrate 20. As illustrated in FIG. 1, vertical conducting portions 7 for electrical conduction between the element substrate 10 and the counter substrate 20 are provided at corners of the counter substrate 20.

The element substrate 10 and the counter substrate 20 are bonded to each other via a sealing material 6 disposed along the outer edge of the counter substrate 20. The liquid crystal layer 5 is provided by enclosing liquid crystal having positive or negative dielectric anisotropy in a gap between the element substrate 10 and the counter substrate 20. In the following description, the element substrate 10 and the counter substrate 20 may be referred to as a pair of substrates.

As illustrated in FIG. 1, when viewed from the normal direction of the element substrate 10 and the counter substrate 20, that is, in a plan view of the liquid crystal device 1, the liquid crystal device 1 has an overlapping region KA in which the element substrate 10 and the counter substrate 20 overlap each other. The overlapping region KA has a rectangular shape, and the sealing material 6 is disposed along the outer edge of the overlapping region KA. Inside of the sealing material 6, a display region E including a plurality of pixels P arranged in a matrix is provided.

As the sealing material 6, for example, an adhesive such as a thermosetting, photocurable, or electron beam-curable epoxy resin is adopted. Spacers (not illustrated) are mixed in the sealing material 6 in order to keep the distance between the pair of substrates constant.

The element substrate 10 is larger than the counter substrate 20 in a planar view. Therefore, the liquid crystal device 1 of the present embodiment includes a first protruding region HA1 in which the element substrate 10 protrudes to the outside of the counter substrate 20 and a second protruding region HA2 in which the element substrate 10 protrudes to the outside of the counter substrate 20.

The element substrate 10 includes a plurality of pixel electrodes 11 and an external coupling terminal portion 8 that supplies an electric signal to each of the plurality of pixel electrodes 11. The plurality of pixel electrodes 11 are provided for the respective pixels P in the display region E.

The external coupling terminal portion 8 is provided in the first protruding region HA1. The external coupling terminal portion 8 includes a plurality of coupling terminals 8a. The coupling terminals 8a are coupled to a circuit that drives the pixel electrodes 11 by a plurality of wires (not illustrated). Thus, the external coupling terminal portion 8 is coupled to an external device via the plurality of coupling terminals 8a, thereby supplying predetermined signals supplied from the external device to the respective pixel electrodes 11.

The rectangular overlapping region KA has four sides including a first side K1 along the X direction, a second side K2 parallel to the Y direction and orthogonal to the first side K1, a third side K3 located at the upside of the first side K1, parallel to the first side K1, and orthogonal to the second side K2, and a fourth side K4 located at the right side of the second side K2, parallel to the second side K2, and orthogonal to the first side K1 and the third side K3.

The first protruding region HA1 protrudes to the downside (outside) of the first side K1 among the four sides of the overlapping region KA. The second protruding region HA2 protrudes to the left side (outside) of the second side K2 among the four sides of the overlapping region KA.

As illustrated in FIG. 2, the element substrate 10 includes a first base material 10A, a pixel electrode 11, a first light-shielding layer 12, a first insulating layer 13, a TFT 14, a second insulating layer 15, a second light-shielding layer 16, a third insulating layer 17, a thermally conductive layer 30, a fourth insulating layer 18, and a first alignment film 19. The first base material 10A is formed of a material having light permeability such as glass or quartz.

The first light-shielding layer 12 is provided on the first base material 10A. The first light-shielding layer 12 is formed in a lattice pattern so as to overlap the second light-shielding layer 16 as the upper layer in the plan view. The first light-shielding layer 12 and the second light-shielding layer 16 are disposed so as to sandwich the TFT 14 therebetween in the Z direction which is the thickness direction of the element substrate 10. The first light-shielding layer 12 overlaps at least a channel region of the TFT 14 in the plan view.

The first light-shielding layer 12 and the second light-shielding layer 16 are provided, thereby suppressing incidence of light on the TFT 14. A first opening 12a as a region surrounded by the first light-shielding layer 12 and a second opening 16a as a region surrounded by the second light-shielding layer 16 overlap each other in the plan view, through which light is transmitted. In the pixel P, a region overlapping the first opening 12a and the second opening 16a in the plan view is a pixel opening OP, through which light is transmitted. The pixel opening OP is disposed substantially parallel to a plane including the X direction and the Y direction.

The first insulating layer 13 is provided so as to cover the first base material 10A and the first light-shielding layer 12. The first insulating layer 13 is made of, for example, an inorganic material such as SiO₂.

The TFT 14 is provided on the first insulating layer 13. The TFT 14 is a switching element that drives the pixel electrode 11. The TFT 14 includes a semiconductor layer, a gate electrode, a source electrode, and a drain electrode (not illustrated).

The second insulating layer 15 is provided to cover the first insulating layer 13 and the TFT 14. The second insulating layer 15 is made of, for example, an inorganic material such as SiO₂. The second insulating layer 15 includes a gate insulating film for insulation between the semiconductor layer and the gate electrode of the TFT 14. The unevenness of the surface caused by the TFTs 14 is planarized by the second insulating layer 15. The second light-shielding layer 16 is provided on the second insulating layer 15. The third insulating layer 17 made of an inorganic material such as SiO₂ is provided to cover the second insulating layer 15 and the second light-shielding layer 16.

The thermally conductive layer 30 is provided on the third insulating layer 17. The thermally conductive layer 30 is formed of a material having higher thermal conductivity than the thermal conductivity of the constituent material of the element substrate 10 having a multilayer structure. That is, the thermally conductive layer 30 is formed of a material having higher thermal conductivity than constituent materials forming the other layers in the element substrate 10. That is, the thermally conductive layer 30 is formed of a material capable of improving the thermal conductivity of the entire element substrate 10 when provided in the element substrate 10. Therefore, the constituent material of the thermally conductive layer 30 is appropriately set according to the constituent materials of the element substrate 10. The thermally conductive layer 30 of the present embodiment is made of, for example, a metal material such as Al, Cu, Au, W, or Ti. The thickness of the thermally conductive layer 30 is, for example, 1 to 2 μm. For example, when the first light-shielding layer 12 and the second light-shielding layer 16 of the element substrate 10 are formed of a metal material, the thermally conductive layer 30 is formed of a metal material having higher thermal conductivity than the thermal conductivity of the metal material forming the first light-shielding layer 12 and the second light-shielding layer 16.

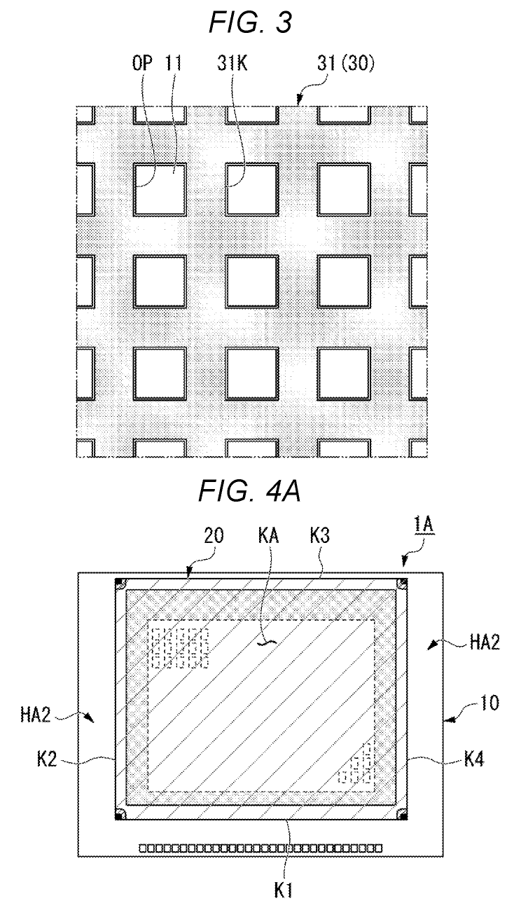

FIG. 3 shows a planar shape of the thermally conductive layer 30.

As shown in FIG. 3, the thermally conductive layer 30 includes a lattice-shaped portion 31 as a lattice-like section. The lattice-shaped portion 31 of the thermally conductive layer 30 has openings 31K at positions corresponding to the plurality of pixel electrodes 11. That is, the thermally conductive layer 30 does not overlap the pixel electrodes 11 in the plan view. In the case of the present embodiment, the opening 31K of the thermally conductive layer 30 preferably has a size equal to or larger than the pixel opening OP. According to the configuration, since the light transmitted through the opening 31K of the thermally conductive layer 30 can be efficiently transmitted through the pixel opening OP, it is possible to suppress the occurrence of a light loss due to the thermally conductive layer 30 blocking the light incident on the pixel electrode 11. The thermally conductive layer 30 is provided to be insulated from the other wires and conductive materials in the element substrate 10.

The fourth insulating layer 18 is provided on the third insulating layer 17 so as to cover the thermally conductive layer 30.

The respective pixel electrodes 11 are provided on the fourth insulating layer 18. Each pixel electrode 11 is provided to correspond to each pixel P. The pixel electrode 11 is disposed in a region overlapping the pixel opening OP of each pixel P in the plan view. The pixel electrode 11 is formed of, for example, a transparent conductive film such as indium tin oxide (ITO) or indium zinc oxide (IZO). The first alignment film 19 is provided so as to cover the pixel electrodes 11. The liquid crystal layer 5 is enclosed between the first alignment film 19 at the element substrate 10 side and a second alignment film 25 at the counter substrate 20 side.

Each pixel electrode 11 is electrically coupled to the corresponding TFT 14. The pixel electrode 11 and the TFT 14 are electrically coupled to each other via a contact hole or a relay electrode (not illustrated) provided between the insulating layers.

The first alignment film 19 and the second alignment film 25 are selected based on the optical design of the liquid crystal device 1. Examples of the material of the first alignment film 19 and the second alignment film 25 include an inorganic alignment film of silicon oxide or the like and an organic alignment film of polyimide or the like.

The TFT 14 and an electrode, a wire, and the like (not illustrated) that supplies an electric signal to the TFT 14 are provided in a region overlapping the first light-shielding layer 12 and the second light-shielding layer 16 in the plan view. The electrode, the wire, and the like may be configured to serve as the first light-shielding layer 12 and the second light-shielding layer 16.

The counter substrate 20 includes a second base material 20A, a light-shielding layer 22, an insulating layer 23, a common electrode 24, and the second alignment film 25.

The light-shielding layer 22 is provided so as to surround the periphery of the display region E shown in FIG. 1. The insulating layer 23 is made of, for example, an inorganic material such as SiO₂, and is provided on the second base material 20A so as to cover the light-shielding layer 22. The common electrode 24 is provided so as to cover the insulating layer 23. The common electrode 24 is formed across the plurality of pixels P. The common electrode 24 is formed of, for example, a transparent conductive film such as indium tin oxide (ITO) or indium zinc oxide (IZO). The second alignment film 25 is provided so as to cover the common electrode 24.

The liquid crystal device 1 of the present embodiment is used as a liquid crystal light valve of a projector PJ as will be described later. Therefore, heat may be generated by light incident from a light source.

In the liquid crystal device 1 of the present embodiment, for example, light emitted from a light source or the like is incident on the liquid crystal layer 5 from the counter substrate 20 side. When the liquid crystal device 1 generates heat, the temperature of not only the counter substrate 20 at the light incident side but also the entire liquid crystal panel rises. In particular, heat is more easily transferred to the element substrate 10 with the thermally conductive layer 30 than to the counter substrate 20 without the thermally conductive layer 30.

The first protruding region HA1 is provided with the external coupling terminal portion 8 for coupling to an external device, and hard to contribute to heat dissipation of the liquid crystal panel. In contrast, the liquid crystal device 1 of the present embodiment has the second protruding region HA2 in which the element substrate 10 protrudes outside the overlapping region KA, and thus it is possible to improve the cooling property of the element substrate 10 by applying, for example, cold air to the second protruding region HA2. In the case of the liquid crystal device 1 of the present embodiment, since the element substrate 10 has the thermally conductive layer 30, the heat of the entire panel is easily transferred to the element substrate 10 side, and the heat of the entire panel can be efficiently released via the element substrate 10 by cooling the second protruding region HA2.

Therefore, according to the liquid crystal device 1 of the present embodiment, it is possible to implement a highly reliable liquid crystal device in which defects such as a malfunction and a failure of the liquid crystal panel due to a high temperature are suppressed by increasing the heat dissipation of the entire liquid crystal panel.

In the liquid crystal device 1 of the first embodiment, the second protruding region HA2 protrudes to the left side (outside) of the second side K2 of the overlapping region KA, but the protruding direction of the second protruding region HA2 is not limited thereto.

### First Modification

Subsequently, a first modification of the first embodiment will be described.

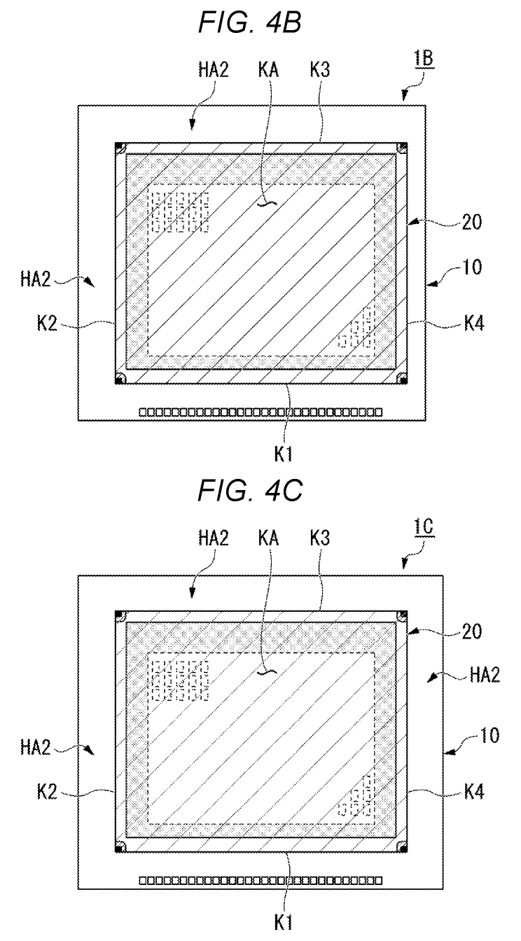

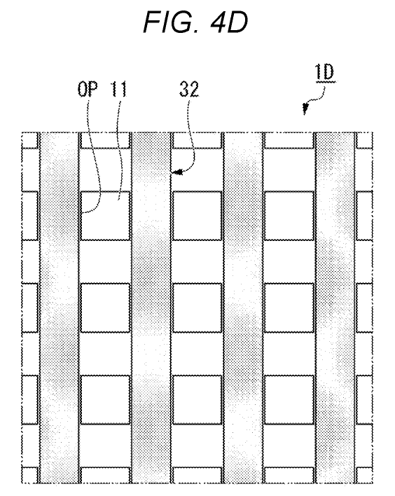

FIG. 4A is a schematic plan view showing a configuration of a liquid crystal device of the present modification.

As illustrated in FIG. 4A, in a liquid crystal device 1A of the present modification, the second protruding region HA2 protrudes not only to the left side of the second side K2 but also to the right side of the fourth side K4 among the four sides of the overlapping region KA. That is, in the case of the present modification, the second protruding region HA2 protrudes to both the left and the right sides with respect to the overlapping region KA.

According to the liquid crystal device 1A of the present modification, since the second protruding region HA2 protrudes in two directions with respect to the overlapping region KA, it is possible to improve the heat dissipation of the element substrate 10 compared to the liquid crystal device 1 of the first embodiment.

### Second Modification

Subsequently, a second modification of the first embodiment will be described.

FIG. 4B is a schematic plan view showing a configuration of a liquid crystal device of the present modification.

As illustrated in FIG. 4B, in a liquid crystal device 1B of the present modification, the second protruding region HA2 protrudes not only to the left side of the second side K2 but also to the upside of the third side K3 among the four sides of the overlapping region KA. That is, in the case of the present modification, the second protruding region HA2 protrudes to the left side and the upside with respect to the overlapping region KA.

According to the liquid crystal device 1B of the present modification, since the second protruding region HA2 protrudes in two directions with respect to the overlapping region KA, it is possible to improve the heat dissipation of the element substrate 10 compared to the liquid crystal device 1 of the first embodiment.

### Third Modification

Subsequently, a third modification of the first embodiment will be described.

FIG. 4C is a schematic plan view showing a configuration of a liquid crystal device of the present modification.

As illustrated in FIG. 4C, in a liquid crystal device 1C of the present modification, the second protruding region HA2 protrudes to the left side of the second side K2, the upside of the third side K3, and the right side of the fourth side K4 among the four sides of the overlapping region KA. That is, in the case of the present modification, the second protruding region HA2 protrudes to both the left and the right sides and the upside with respect to the overlapping region KA.

According to the liquid crystal device 1C of the present modification, since the second protruding region HA2 protrudes in three directions with respect to the overlapping region KA, it is possible to further improve the heat dissipation of the element substrate 10 compared to the configurations of the first modification and the second modification.

In addition, in the liquid crystal device 1 of the first embodiment, the planar shape of the thermally conductive layer 30 is the lattice shape, but the planar shape of the thermally conductive layer is not limited thereto as long as the thermally conductive layer does not overlap the pixel electrodes 11.

### Fourth Modification

Subsequently, a fourth modification of the first embodiment will be described.

FIG. 4D is a schematic plan view showing a configuration of a liquid crystal device of the present modification.

As illustrated in FIG. 4D, in a liquid crystal device 1D of the present modification, the planar shape of a thermally conductive layer 32 is a stripe shape. The stripe-shaped thermally conductive layer 32 is provided to extend along a first direction of the plurality of pixel electrodes 11 arranged in a matrix and be located between the pixel electrodes 11 adjacent to each other in a second direction orthogonal to the first direction. Therefore, the stripe-shaped thermally conductive layer 32 is disposed so as not to overlap the respective pixel electrodes 11 in the plan view. According to the configuration, the light transmitted through the gap of the stripe-shaped thermally conductive layer 32 can be efficiently transmitted through the pixel opening OP of the pixel electrode 11.

According to the liquid crystal device 1D of the present modification, since the element substrate 10 includes the stripe-shaped thermally conductive layer 32, similarly to the liquid crystal device 1 of the first embodiment, it is possible to improve the heat dissipation of the element substrate 10 while suppressing the occurrence of a light loss due to blocking of light incident on the pixel electrode 11 by the thermally conductive layer 32.

### Second Embodiment

Next, another configuration in the liquid crystal device will be described as a second embodiment of the present disclosure. The configurations and members common to the first embodiment have the same signs, and the detailed description thereof will be omitted or simplified.

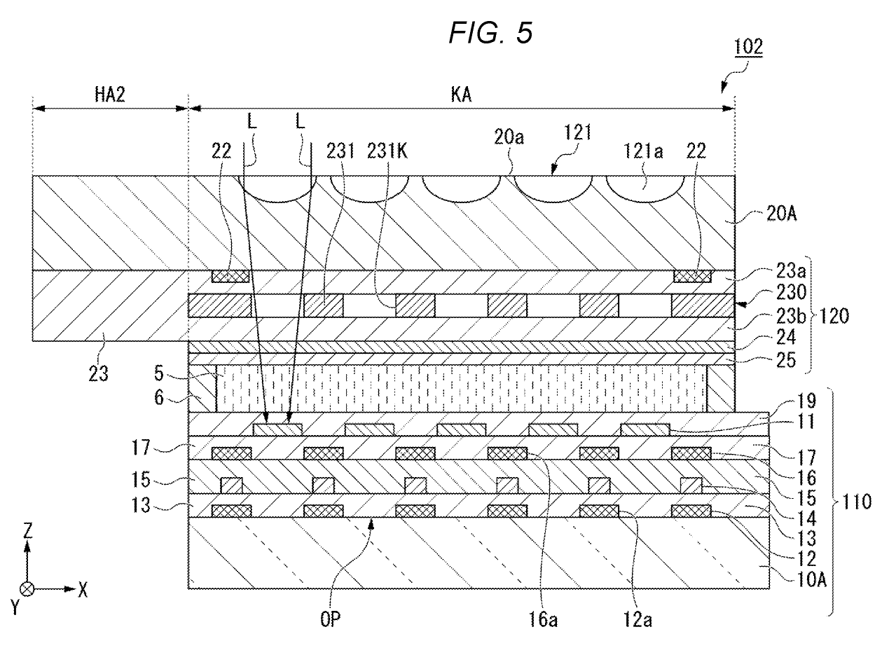

FIG. 5 is a schematic diagram showing a cross-sectional structure of the liquid crystal device of the present embodiment.

As illustrated in FIG. 5, a liquid crystal device 102 of the present embodiment includes an element substrate 110, a counter substrate 120 disposed to face the element substrate 110, and a liquid crystal layer 5. The element substrate 110 includes a first base material 10A, a pixel electrode 11, a first light-shielding layer 12, a first insulating layer 13, a TFT 14, a second insulating layer 15, a second light-shielding layer 16, a third insulating layer 17, and a first alignment film 19. In contrast to the element substrate 10 of the first embodiment, the element substrate 110 of the present embodiment does not include the thermally conductive layer 30 and the fourth insulating layer 18, and the pixel electrodes 11 and the first alignment film 19 covering the pixel electrodes 11 are provided on the third insulating layer 17.

The counter substrate 120 of the present embodiment includes a second base material 20A, a lens array 121, a lower insulating layer 23a, a light-shielding layer 22, a thermally conductive layer 230, an upper insulating layer 23b, a common electrode 24, and a second alignment film 25.

The lens array 121 includes a plurality of lenses 121a provided to correspond to the plurality of pixel electrodes 11. Each lens 121a of the lens array 121 is made of a light-transmissive material such as SiON or Al ₂O₃ embedded in a recess provided in a surface 20a of the second base material 20A. A material having a higher refractive index than the second base material 20A is selected for the lens 121a so as to generate a predetermined refractive index difference.

The lower insulating layer 23a is made of, for example, an inorganic material such as SiO₂, and is provided on the second base material 20A so as to cover the light-shielding layer 22.

The thermally conductive layer 230 is provided on the lower insulating layer 23a. The thermally conductive layer 230 is made of a material having higher thermal conductivity than the thermal conductivity of the constituent material of the counter substrate 120 having a multilayer structure. The thermally conductive layer 230 of the present embodiment is made of a metal material such as Al, Cu, Au, W, or Ti. That is, the thermally conductive layer 230 is made of a material having higher thermal conductivity than the constituent materials forming the other layers in the counter substrate 120. That is, the thermally conductive layer 230 is made of a material capable of improving the thermal conductivity of the entire counter substrate 120 when provided in the counter substrate 120. Therefore, the constituent material of the thermally conductive layer 230 is appropriately set according to the constituent material of the counter substrate 120. The thickness of the thermally conductive layer 230 is, for example, 1 to 2 μm. For example, when the light-shielding layer 22 of the counter substrate 120 is formed of a metal material, the thermally conductive layer 230 is formed of a metal material having higher thermal conductivity than the metal material forming the light-shielding layer 22.

In the liquid crystal device 102 according to the present embodiment, light L incident from the counter substrate 120 is condensed by the lenses 121a of the lens array 121 and travels into the panel. Here, the incident light L reaches the thermally conductive layer 230 provided under the lens array 121.

The thermally conductive layer 230 of the present embodiment includes a lattice-shaped portion 231 similar to that of the thermally conductive layer 30 shown in FIG. 3. The lattice-shaped portion 231 of the thermally conductive layer 230 has openings 231K at positions corresponding to the condensing positions of the respective lenses 121a of the lens array 121. Therefore, the thermally conductive layer 230 can cause the incident light L to enter the panel without blocking the light L. Accordingly, the light L transmitted through each opening 231K of the thermally conductive layer 230 can favorably enter the corresponding pixel electrode 11. In addition, since the opening 231K is provided at the position corresponding to the condensing position, the size of the opening 231K is minimized, and thus it is possible to increase the surface area of the thermally conductive layer 230 and increase the heat dissipation.

The upper insulating layer 23b is provided on the lower insulating layer 23a so as to cover the thermally conductive layer 230. As a result, the insulating layer 23 of a stacked structure of the lower insulating layer 23a and the upper insulating layer 23b is formed. The common electrode 24 is provided so as to cover the upper insulating layer 23b. The second alignment film 25 is provided so as to cover the common electrode 24.

The liquid crystal device 102 of the present embodiment has a second protruding region HA2 at the counter substrate 120 side having the thermally conductive layer 230. In the liquid crystal device 102 of the embodiment, since the counter substrate 120 has the thermally conductive layer 230, the heat of the entire panel is easily transferred to the counter substrate 120 side. Accordingly, the liquid crystal device 102 can efficiently release the heat of the entire panel via the counter substrate 120 by, for example, applying cold air to the second protruding region HA2.

Therefore, according to the liquid crystal device 102 of the present embodiment, similarly to the first embodiment, it is possible to implement a highly reliable liquid crystal device in which defects such as a malfunction and a failure of the liquid crystal panel due to a high temperature are suppressed by increasing the heat dissipation of the entire liquid crystal panel.

### Third Embodiment

Next, another configuration of the liquid crystal device will be described as a third embodiment of the present disclosure. The configurations and members common to the first embodiment have the same signs, and the detailed description thereof will be omitted or simplified.

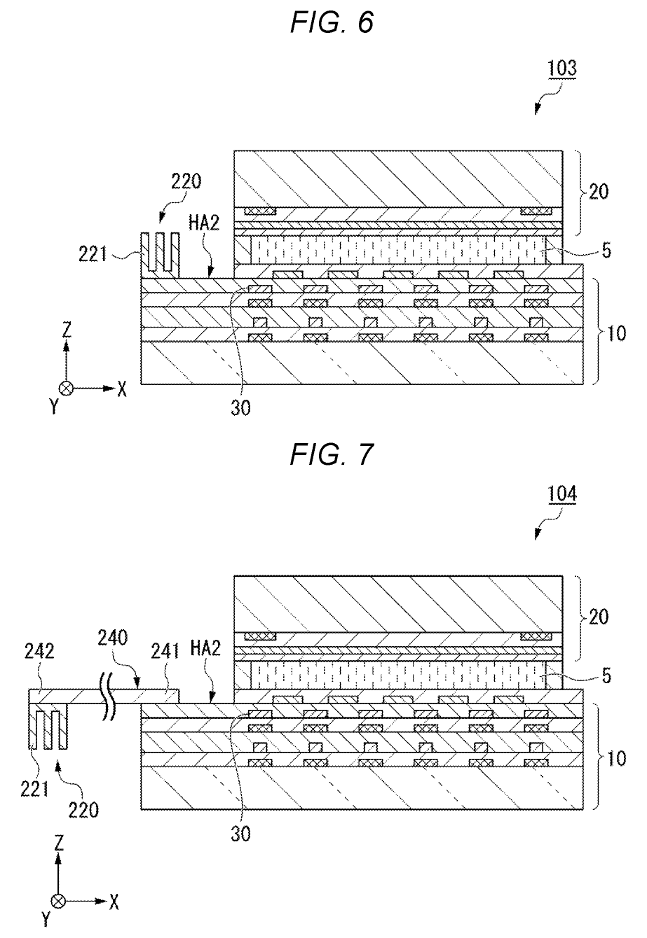

FIG. 6 is a schematic diagram showing a cross-sectional structure of the liquid crystal device of the present embodiment.

As illustrated in FIG. 6, a liquid crystal device 103 of the present embodiment includes an element substrate 10, a counter substrate 20, a liquid crystal layer 5, and a heat dissipation member 220.

The heat dissipation member 220 is provided in a second protruding region HA2. The heat dissipation member 220 is thermally connected to the element substrate 10 at the side protruding to the second protruding region HA2.

Here, in the specification, being thermally connected means being connected in a state in which heat can be transferred between two members, and includes not only a state in which the two members are completely in contact with each other but also a state in which the two members are disposed with a slight gap therebetween. Furthermore, another member may be interposed between two members as long as heat transfer occurs between the two members.

The heat dissipation member 220 is a metal heat sink. In the present embodiment, the heat dissipation member 220 is made of, for example, aluminum. The thermal conductivity of the heat dissipation member 220 is preferably higher than that of the thermally conductive layer 30. The heat dissipation member 220 includes a plurality of heat dissipation fins 221.

The heat dissipation member 220 is not limited to the configuration in which a separate member is provided on the element substrate 10, and is not limited as long as the heat dissipation area of the element substrate 10 at the side protruding to the second protruding region HA2 is increased. For example, the heat dissipation area of the surface of the element substrate 10 may be increased by using an uneven structure directly formed on the surface of the element substrate 10 at the side protruding to the second protruding region HA2 as the heat dissipation member.

Thermally conductive grease or a thermally conductive adhesive may be provided on the contact surface between the heat dissipation member 220 and the element substrate 10 in the second protruding region HA2. According to the configuration, the thermal conductivity from the second protruding region HA2 to the heat dissipation member 220 can be further increased.

According to the liquid crystal device 103 of the present embodiment, since the heat dissipation member 220 is provided in the second protruding region HA2, it is possible to more efficiently dissipate the heat of the second protruding region HA2 via the heat dissipation member 220. Accordingly, the cooling efficiency of the second protruding region HA2 is increased, and thus the cooling performance in the entire liquid crystal device 103 can be further increased.

Therefore, according to the liquid crystal device 103 of the present embodiment, it is possible to implement a liquid crystal device in which the reliability is further improved by further increasing the heat dissipation of the entire liquid crystal panel.

### Fourth Embodiment

Next, another configuration of the liquid crystal device will be described as a fourth embodiment of the present disclosure. The configurations and members common to the first embodiment have the same signs, and the detailed description thereof will be omitted or simplified.

FIG. 7 is a schematic diagram showing a cross-sectional structure of the liquid crystal device of the present embodiment.

As illustrated in FIG. 7, a liquid crystal device 104 of the present embodiment includes an element substrate 10, a counter substrate 20, a liquid crystal layer 5, a heat dissipation member 220, and a heat transport member 240.

The heat transport member 240 is provided in a second protruding region HA2. The heat transport member 240 is thermally connected to the element substrate 10 at the side protruding to the second protruding region HA2. The heat transport member 240 is, for example, a pipe-shaped vapor chamber.

The heat transport member 240 transports heat from the second protruding region HA2 for cooling. The heat transport member 240 including the vapor chamber holds a refrigerant (not illustrated) in a sealed state, absorbs the heat of the second protruding region HA2 by a heat absorbing portion 241, and releases the heat absorbed by the heat absorbing portion 241 by a heat dissipating portion 242.

The device configuration may be reduced in size by using a heat pipe as the heat transport member 240 instead of the vapor chamber. As the heat transport member 240, a liquid-cooling heat transport member that transports the heat absorbed from the second protruding region HA2 to the heat dissipation portion by a cooling fluid circulating inside may be used.

According to the liquid crystal device 104 of the present embodiment, by providing the heat transport member 240 in the second protruding region HA2, the heat dissipation location of the second protruding region HA2 can be moved to a desired location via the heat transport member 240. Therefore, even when the space surrounding the second protruding region HA2 is small and it is difficult to apply cooling air to the second protruding region HA2 or it is difficult to directly provide the heat dissipation member 220 in the second protruding region HA2, the heat dissipation location of the second protruding region HA2 can be moved to a location where the surrounding space is sufficient by the heat transport member 240. Thus, the degree of freedom in heat dissipation design of the second protruding region HA2 can be increased.

In the case of the present embodiment, the heat dissipation member 220 is provided in the heat dissipation portion 242 of the heat transport member 240. According to the configuration, the heat transport performance of the heat transport member 240 can be further increased by increasing the heat dissipation of the heat dissipation portion 242 of the heat transport member 240.

As described above, according to the liquid crystal device 104 of the embodiment, it is possible to implement a liquid crystal device in which the reliability is further improved by further increasing the heat dissipation of the entire liquid crystal panel.

### Fifth Embodiment

Next, another configuration of the liquid crystal device will be described as a fifth embodiment of the present disclosure. The configurations and members common to the first embodiment have the same signs, and the detailed description thereof will be omitted or simplified.

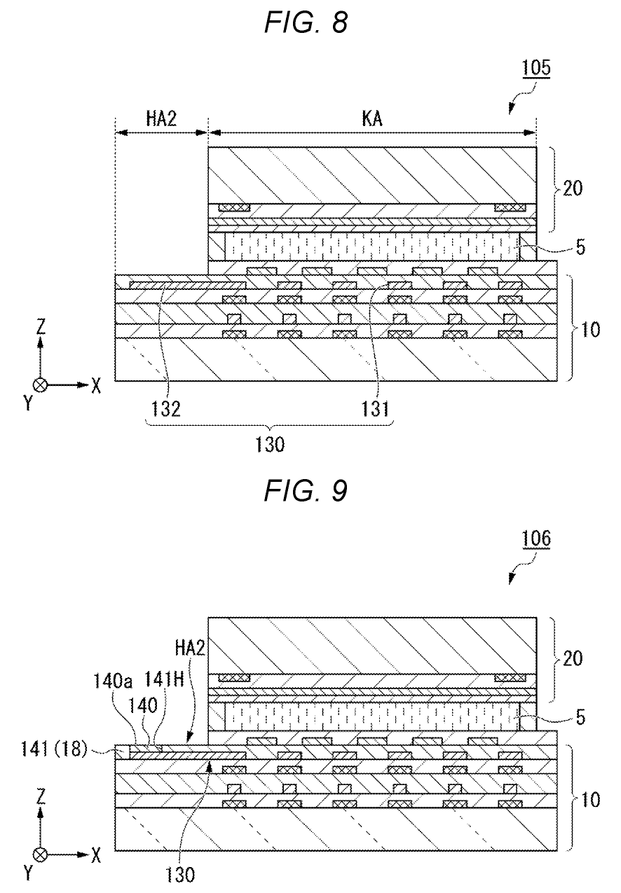

FIG. 8 is a schematic diagram showing a cross-sectional structure of the liquid crystal device of the present embodiment.

As illustrated in FIG. 8, in a liquid crystal device 105 of the present embodiment, a thermally conductive layer 130 provided on an element substrate 10 extends from an overlapping region KA to a second protruding region HA2.

The thermally conductive layer 130 of the present embodiment includes a first portion 131 provided in the overlapping region KA and a second portion 132 provided in the second protruding region HA2. The first portion 131 has a lattice shape having openings at positions corresponding to pixel electrodes 11. The second portion 132 is coupled to the first portion 131 and has a solid film shape spreading over substantially the entire second protruding region HA2. The first portion 131 may have a stripe shape extending along the gap between the adjacent pixel electrodes 11.

According to the configuration, the heat dissipation by the thermally conductive layer 130 can be improved by the second portion 132 while suppressing a light loss due to the thermally conductive layer 130 by the first portion 131.

According to the liquid crystal device 105 of the present embodiment, since the thermally conductive layer 130 extending to the second protruding region HA2 is provided, the heat dissipation of the second protruding region HA2 can be further improved. Accordingly, the cooling efficiency of the second protruding region HA2 is increased, and thus the cooling performance in the entire liquid crystal device 105 can be further increased.

Therefore, according to the liquid crystal device 105 of the present embodiment, it is possible to implement a liquid crystal device in which the reliability is further improved by further increasing the heat dissipation of the entire liquid crystal panel.

### Sixth Embodiment

Next, another configuration of the liquid crystal device will be described as a sixth embodiment of the present disclosure. The present embodiment is different from the configuration of the fifth embodiment in that a thermal connection portion thermally connected to the thermally conductive layer 130 is provided in the second protruding region HA2. The configurations and members common to the fifth embodiment have the same signs, and the detailed description thereof will be omitted or simplified.

FIG. 9 is a schematic diagram showing a cross-sectional structure of the liquid crystal device of the present embodiment.

As shown in FIG. 9, a liquid crystal device 106 of the present embodiment further includes a thermal connection portion 140 which is thermally connected to the thermally conductive layer 130 and is located in a part of a region extending to the second protruding region HA2 of the thermally conductive layer 130 compared with the configuration of the fifth embodiment. The thermal connection portion 140 is embedded in a through hole 141H penetrating a sealing layer 141 covering the thermally conductive layer 130 in the second protruding region HA2, and a surface 140a is exposed to the outside. The sealing layer 141 corresponds to a part of the fourth insulating layer 18 covering the thermally conductive layer 130. As the material of the thermal connection portion 140, for example, a metal material such as A l, Cu, Au, W, or Ti is used.

According to the liquid crystal device 106 of the present embodiment, since the thermal connection portion 140 thermally connected to the thermally conductive layer 130 is exposed to the surface layer of the second protruding region HA2, for example, when cold air is applied to the second protruding region HA2, it is possible to efficiently release heat from the thermally conductive layer 130 via the thermal connection portion 140. Accordingly, it is possible to further increase the cooling performance in the entire liquid crystal device 106 by further increasing the cooling efficiency of the second protruding region HA2.

Therefore, according to the liquid crystal device 106 of the embodiment, it is possible to implement a liquid crystal device in which the reliability is further improved by further increasing the heat dissipation of the entire liquid crystal panel.

### Seventh Embodiment

Next, another configuration of the liquid crystal device will be described as a seventh embodiment of the present disclosure. The configurations and members common to the first embodiment have the same signs, and the detailed description thereof will be omitted or simplified.

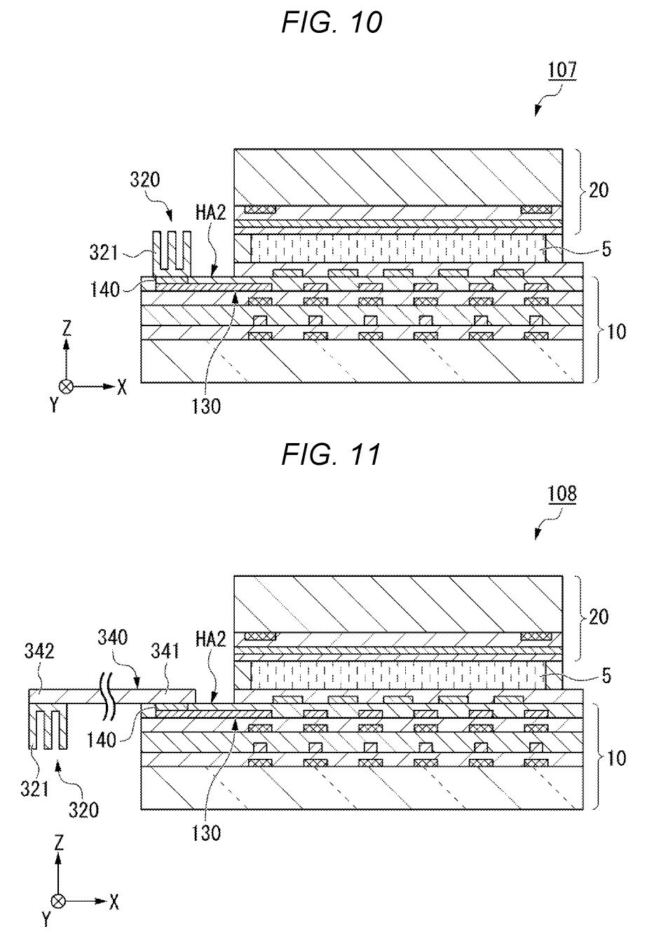

FIG. 10 is a schematic diagram showing a cross-sectional structure of the liquid crystal device of the present embodiment.

As shown in FIG. 10, a liquid crystal device 107 of the present embodiment further includes a heat dissipation member 320 compared with the configuration of the sixth embodiment.

The heat dissipation member 320 is provided in the second protruding region HA2. The heat dissipation member 320 is thermally connected to the thermal connection portion 140 provided in the second protruding region HA2. The heat dissipation member 320 is, for example, an aluminum heat sink. The thermal conductivity of the heat dissipation member 320 is preferably higher than that of the thermal connection portion 140. The heat dissipation member 320 includes a plurality of heat dissipation fins 321.

Thermally conductive grease or a thermally conductive adhesive may be provided on the contact surface between the heat dissipation member 320 and the thermal connection portion 140 to further increase the thermal conductivity from the thermal connection portion 140 to the heat dissipation member 320.

According to the liquid crystal device 107 of the present embodiment, since the heat dissipation member 320 is provided in the thermal connection portion 140 which is thermally connected to the thermally conductive layer 130 and is exposed to the surface layer of the second protruding region HA2, it is possible to efficiently dissipate heat from the thermal connection portion 140 via the heat dissipation member 320. Accordingly, the heat dissipation of the thermally conductive layer 130 is increased, and thus it is possible to further increase the cooling performance in the entire liquid crystal device 107 compared with the configuration of the sixth embodiment.

Therefore, according to the liquid crystal device 107 of the present embodiment, it is possible to implement a liquid crystal device in which the reliability is further improved by further increasing the heat dissipation of the entire liquid crystal panel.

### Eighth Embodiment

Next, another configuration of the liquid crystal device will be described as an eighth embodiment of the present disclosure. The configurations and members common to the first embodiment have the same signs, and the detailed description thereof will be omitted or simplified.

FIG. 11 is a schematic diagram showing a cross-sectional structure of the liquid crystal device of the present embodiment.

As shown in FIG. 11, a liquid crystal device 108 of the present embodiment further includes a heat transport member 340 compared with the configuration of the seventh embodiment.

The heat transport member 340 is provided in the second protruding region HA2. The heat transport member 340 is thermally connected to the thermal connection portion 140 which is exposed on the surface layer of the second protruding region HA2. The heat transport member 340 is, for example, a pipe-shaped vapor chamber.

The heat transport member 340 cools by transporting heat from the thermal connection portion 140. The heat transport member 340 including the vapor chamber has a heat absorbing portion 341 that absorbs the heat of the thermal connection portion 140 and a heat dissipating portion 342 that releases the heat absorbed by the heat absorbing portion 341.

According to the liquid crystal device 108 of the present embodiment, by providing the heat transport member 340 thermally connected to the thermal connection portion 140, the heat dissipation location of the thermal connection portion 140 can be moved to a desired location via the heat transport member 340. Therefore, even when the space surrounding the thermal connection portion 140 is small and it is difficult to apply cooling air to the thermal connection portion 140 or it is difficult to directly provide the heat dissipation member in the thermal connection portion 140, the heat dissipation location of the thermal connection portion 140 can be moved to a location where the surrounding space is sufficient by the heat transport member 340. Therefore, the degree of freedom in heat dissipation design of the thermal connection portion 140 can be increased.

In the case of the present embodiment, the heat dissipation member 320 is provided in the heat dissipating portion 342 of the heat transport member 340. According to the configuration, the heat transport performance of the heat transport member 340 can be further increased by increasing the heat dissipation of the heat dissipating portion 342 of the heat transport member 340.

As described above, according to the liquid crystal device 108 of the present embodiment, it is possible to implement a liquid crystal device in which the reliability is further improved by further increasing the heat dissipation of the entire liquid crystal panel.

### Ninth Embodiment

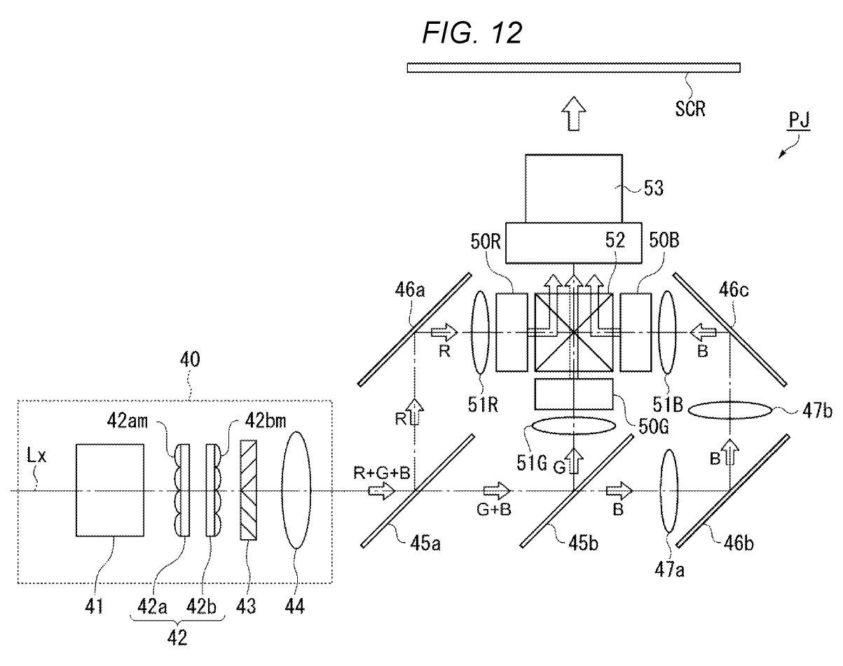

Next, an electronic apparatus will be described as a ninth embodiment of the present disclosure with reference to the drawings. FIG. 12 is a schematic diagram showing a configuration of an electronic apparatus. The electronic apparatus according to the present embodiment is a projector including the liquid crystal device according to any one of the embodiments described above.

As shown in FIG. 12, a projector PJ of the present embodiment includes an illumination device 40, two dichroic mirrors 45a and 45b, three reflection mirrors 46a, 46b, and 46c, two relay lenses 47a and 47b, three field lenses 51R, 51G, and 51B, three liquid crystal light valves 50R, 50G, and 50B, a cross dichroic prism 52, and a projection lens 53.

The illumination device 40 includes a light source 41 including a white light source such as an ultra-high pressure mercury lamp or a halogen lamp, a lens integrator 42, a polarization conversion element 43, and a superimposing lens 44.

The lens integrator 42 includes a first multi-lens 42a and a second multi-lens 42b. The first multi-lens 42a includes a plurality of first small lenses 42am, which divide the illumination light into a plurality of partial luminous fluxes.

The surfaces of the first small lenses 42am as the lens surface of the first multi-lens 42a and each image formation region of the liquid crystal light valves 50R, 50G, and 50B are conjugate to each other. Therefore, the shape of each first small lens 42am is substantially similar to the shape of the image formation regions of the liquid crystal light valves 50R, 50G, and 50B. Accordingly, each of the partial luminous fluxes output from the first multi-lens 42a efficiently enters the image formation regions of the liquid crystal light valves 50R, 50G, and 50B.

The second multi-lens 42b includes a plurality of second small lenses 42bm corresponding to the plurality of first small lenses 42am of the first multi-lens 42a. The second multi-lens 42b, along with the superimposing lens 44, forms an image of each of the first small lenses 42am of the first multi-lens 42a in the vicinity of the image formation region of each of the liquid crystal light valves 50R, 50G, and 50B.

The illumination light having passed through the lens integrator 42 enters the polarization conversion element 43. The polarization conversion element 43 is formed by arranging a polarization separation layer and a half-wave plate in an array. The polarization conversion element 43 converts the illumination light into a predetermined polarized component.

The dichroic mirror 45a reflects a red light R and transmits a green light G and a blue light B among the polarized luminous fluxes emitted from the illumination device 40. The other dichroic mirror 45b reflects the green light G transmitted through the dichroic mirror 45a and transmits the blue light B.

The red light R reflected by the dichroic mirror 45a is reflected by the reflection mirror 46a and enters the liquid crystal light valve 50R via the field lens 51R. The green light G reflected by the dichroic mirror 45b enters the liquid crystal light valve 50G via the field lens 51G. The blue light B transmitted through the dichroic mirror 45b enters the liquid crystal light valve 50B via a light guide system including the two relay lenses 47a and 47b, the field lens 51B, and the two reflection mirrors 46b and 46c.

The transmissive liquid crystal light valves 50R, 50G, and 50B as light modulation elements are disposed to face incident surfaces of the cross dichroic prism 52 for each color light. The color lights incident on the liquid crystal light valves 50R, 50G, and 50B are modulated based on image information and emitted toward the cross dichroic prism 52.

The cross dichroic prism 52 is configured by bonding four rectangular prisms, and a dielectric multilayer film that reflects the red light and a dielectric multilayer film that reflects the blue light are formed in a cross shape on the inner surface thereof. The three color lights are combined by the dielectric multilayer films into a light representing a color image. The composed light is projected on a screen SCR by the projection lens 53 as a projection optical system and the image enlarged and displayed.

For example, the liquid crystal device 1 of the first embodiment is applied to the liquid crystal light valves 50R, 50G, and 50B. Each of the liquid crystal light valves 50R, 50G, and 50B is disposed between a pair of polarization elements, which are disposed in a crossed Nicol arrangement at the light incident side and the light emission side of the color light with a gap therebetween.

According to the configuration of the projector PJ of the present embodiment, since the highly reliable liquid crystal device 1 in which defects such as a malfunction and a failure of the liquid crystal panel due to a high temperature are suppressed is provided as the liquid crystal light valves 50R, 50G, and 50B, it is possible to implement a highly reliable projector that projects a bright image with high quality.

In the present embodiment, the projector is exemplified as the electronic apparatus including the liquid crystal device, but the present disclosure is not limited thereto. Examples of the electronic apparatus including the liquid crystal device according to the present disclosure include a projection-type head-up display, a direct-view-type head-mounted display, a personal computer, a digital camera, and a liquid crystal television.

Note that the technical scope of the present disclosure is not limited to the embodiments described above, and various changes can be made thereto without departing from the scope of the present disclosure.

For example, in the liquid crystal device of the first embodiment, the case where the thermally conductive layer 30 is provided at the first base material 10A side lower than the pixel electrode 11 in the element substrate 10 has been described as an example, but the thermally conductive layer 30 may be provided at the liquid crystal layer 5 side upper than the pixel electrode 11.

### SUMMARY OF PRESENT DISCLOSURE

The present disclosure is summarized below as appendices.

### Appendix 1

An electro-optical device includes a first substrate having a plurality of pixel electrodes and an external coupling terminal portion that supplies an electric signal to each of the plurality of pixel electrodes, a second substrate disposed to face the first substrate, and an electro-optical material layer sandwiched between the first substrate and the second substrate, wherein a rectangular overlapping region in which the first substrate and the second substrate overlap each other when viewed from a normal direction of the first substrate and the second substrate is provided, a first protruding region in which the first substrate protrudes to an outside of the second substrate is provided outside a first side among four sides of the overlapping region, and the external coupling terminal portion is provided in the first protruding region, a second protruding region in which one of the first substrate and the second substrate protrudes to an outside of the other is provided outside a second side different from the first side, and the substrate at the side protruding to the second protruding region includes a thermally conductive layer made of a material having higher thermal conductivity than a constituent material of the substrate.

In the configuration of Appendix 1, since the first protruding region is provided with the external coupling terminal portion for coupling to the external device, and hard to contribute to heat dissipation. In contrast, according to the configuration, since the substrate at the side protruding to the outside of the overlapping region has the second protruding region, for example, by applying cold air to the second protruding region, the cooling property of the substrate at the protruding side can be increased. Furthermore, since the substrate at the protruding side has the thermally conductive layer, the heat of the entire panel is easily transferred to the protruding substrate side, and the heat of the entire panel can be efficiently released by cooling the second protruding region.

Therefore, according to the configuration, it is possible to implement a highly reliable electro-optical device in which defects such as a malfunction and a failure of the panel due to a high temperature are suppressed by increasing the heat dissipation of the entire panel.

### Appendix 2

In the electro-optical device according to Appendix 1, the thermally conductive layer is made of a metal material and includes a lattice-shaped or stripe-shaped portion having openings at positions corresponding to the plurality of pixel electrodes when viewed from the normal direction of the first substrate and the second substrate.

According to the configuration of Appendix 2, since the thermally conductive layer has a shape hard to overlap the pixel electrode in the plan view, the thermally conductive layer does not block light incident on the pixel electrode. Therefore, light can be efficiently incident on the pixel electrode.

### Appendix 3

In the electro-optical device according to Appendix 2, the second substrate has a lens array including a plurality of lenses provided to correspond to the plurality of pixel electrodes, and the thermally conductive layer includes a lattice-shaped portion having an opening at a position corresponding to a condensing position of each of the plurality of lenses.

According to the configuration of Appendix 3, since the thermally conductive layer having the opening at the position corresponding to the condensing position is provided, the size of the opening is minimized, and thus it is possible to increase the surface area of the thermally conductive layer and increase the heat dissipation.

### Appendix 4

The electro-optical device according to any one of Appendices 1 to 3, further includes a heat dissipation member provided in the second protruding region, wherein the heat dissipation member is thermally connected to the substrate at the side protruding to the second protruding region.

According to the configuration of Appendix 4, since the heat dissipation member is provided in the second protruding region, heat can be efficiently dissipated from the second protruding region via the heat dissipation member. Accordingly, the heat dissipation of the second protruding region is increased, and thus the cooling performance in the entire electro-optical device can be further increased.

### Appendix 5

The electro-optical device according to any one of Appendices 1 to 3, further includes a heat transport member provided in the second protruding region, wherein the heat transport member is thermally connected to the substrate at the side protruding to the second protruding region.

According to the configuration of Appendix 5, the heat dissipation location of the second protruding region can be moved to a desired location via the heat transport member. Therefore, even when the space surrounding the second protruding region is small and it is difficult to apply the cooling air to the second protruding region, the heat dissipation location of the second protruding region can be moved to a location where the surrounding space is sufficient by the heat transport member. Thus, the degree of freedom in heat dissipation design of the second protruding region can be increased.

### Appendix 6

In the electro-optical device according to any one of Appendices 1 to 5, the thermally conductive layer extends from the overlapping region to the second protruding region.

According to the configuration of Appendix 6, by providing the thermally conductive layer extending to the second protruding region, the heat dissipation of the second protruding region can be further increased.

### Appendix 7

The electro-optical device according to Appendix 6, further includes a sealing layer that seals the thermally conductive layer, and a thermal connection portion that is thermally connected to the thermally conductive layer, is located in a part of a region extending to the second protruding region of the thermally conductive layer, and is exposed to the outside through the sealing layer.

According to the configuration of Appendix 7, since the thermal connection portion thermally connected to the thermally conductive layer is exposed to the surface layer of the second protruding region, for example, when cold air is applied the second protruding region, heat can be efficiently dissipated from the thermally conductive layer via the thermal connection portion. Accordingly, it is possible to further increase the cooling performance in the electro-optical device by further increasing the cooling efficiency of the second protruding region.

### Appendix 8

The electro-optical device according to Appendix 7, further includes a heat dissipation member provided in the second protruding region, wherein the heat dissipation member is thermally connected to the thermal connection portion.

According to the configuration of Appendix 8, since the heat dissipation member is provided in the thermal connection portion, heat can be efficiently dissipated from the thermal connection portion via the heat dissipation member. Accordingly, the heat dissipation of the thermally conductive layer is increased, and thus the cooling performance in the entire electro-optical device can be further increased.

### Appendix 9

The electro-optical device according to Appendix 7 or 8, further includes a heat transport member provided in the second protruding region, wherein the heat transport member is thermally connected to the thermal connection portion.

According to the configuration of Appendix 9, the heat dissipation location of the thermal connection portion can be moved to a desired location via the heat transport member. Therefore, even when the space surrounding the thermal connection portion is small and it is difficult to apply the cooling air to the thermal connection portion or it is difficult to directly provide the heat dissipation member in the thermal connection portion, the heat dissipation location of the thermal connection portion can be moved to a location where the surrounding space is sufficient by the heat transport member. Thus, the degree of freedom in heat dissipation design of the thermal connection portion can be increased.

### Appendix 10

In the electro-optical device according to Appendix 6, the thermally conductive layer has a first portion provided in the overlapping region and a second portion provided in the second protruding region, the first portion is a lattice-shaped or stripe-shaped portion having openings at positions corresponding to the plurality of pixel electrodes when viewed from the normal direction of the first substrate and the second substrate, and the second portion is a solid film-shaped portion coupled to the first portion.

According to the configuration of Appendix 10, it is possible to improve heat dissipation due to the thermally conductive layer by the second portion while suppressing a light loss by the thermally conductive layer by the first portion.

### Appendix 11

An electronic apparatus includes the electro-optical device according to any one of Appendices 1 to 10.

According to the configuration of Appendix 11, since the highly reliable electro-optical device in which defects such as a malfunction and a failure due to a high temperature are suppressed is provided, it is possible to provide a highly reliable electronic apparatus that projects a bright image with high quality.

What is claimed is:

1. An electro-optical device comprising:
a first substrate having a plurality of pixel electrodes and an external coupling terminal portion that supplies an electric signal to each of the plurality of pixel electrodes;
a second substrate disposed to face the first substrate; and
an electro-optical material layer sandwiched between the first substrate and the second substrate, wherein
a rectangular overlapping region in which the first substrate and the second substrate overlap each other when viewed from a normal direction of the first substrate and the second substrate is provided,
a first protruding region in which the first substrate protrudes to an outside of the second substrate is provided outside a first side among four sides of the overlapping region, and the external coupling terminal portion is provided in the first protruding region,
a second protruding region in which one of the first substrate and the second substrate protrudes to an outside of the other is provided outside a second side different from the first side, and
the substrate at the side protruding to the second protruding region includes a thermally conductive layer made of a material having higher thermal conductivity than a constituent material of the substrate.

2. The electro-optical device according to claim 1, wherein
the thermally conductive layer is made of a metal material and includes a lattice-shaped or stripe-shaped portion having openings at positions corresponding to the plurality of pixel electrodes when viewed from the normal direction of the first substrate and the second substrate.

3. The electro-optical device according to claim 2, wherein
the second substrate has a lens array including a plurality of lenses provided to correspond to the plurality of pixel electrodes, and
the thermally conductive layer includes a lattice-shaped portion having an opening at a position corresponding to a condensing position of each of the plurality of lenses.

4. The electro-optical device according to claim 1, further comprising a heat dissipation member provided in the second protruding region, wherein
the heat dissipation member is thermally connected to the substrate at the side protruding to the second protruding region.

5. The electro-optical device according to claim 1, further comprising a heat transport member provided in the second protruding region, wherein
the heat transport member is thermally connected to the substrate at the side protruding to the second protruding region.

6. The electro-optical device according to claim 1, wherein
the thermally conductive layer extends from the overlapping region to the second protruding region.

7. The electro-optical device according to claim 6, further comprising:
a sealing layer that seals the thermally conductive layer; and
a thermal connection portion that is thermally connected to the thermally conductive layer, is located in a part of a region extending to the second protruding region of the thermally conductive layer, and is exposed to the outside through the sealing layer.

8. The electro-optical device according to claim 7, further comprising a heat dissipation member provided in the second protruding region, wherein
the heat dissipation member is thermally connected to the thermal connection portion.

9. The electro-optical device according to claim 8, further comprising a heat transport member provided in the second protruding region, wherein
the heat transport member is thermally connected to the thermal connection portion.

10. The electro-optical device according to claim 6, wherein
the thermally conductive layer includes a first portion provided in the overlapping region and a second portion provided in the second protruding region,
the first portion is a lattice-shaped or stripe-shaped portion having openings at positions corresponding to the plurality of pixel electrodes when viewed from the normal direction of the first substrate and the second substrate, and
the second portion is a solid film-shaped portion coupled to the first portion.

11. An electronic apparatus comprising the electro-optical device according to claim 1.
